(19) United States
(12) Patent Application Publication
(10) Pub. No.: US 2002/0163586 A1
(43) Pub. Date: Nov. 7, 2002

(54) Method and apparatus for capturing image

(75) Inventor: Takafumi Noguchi, Kanagawa (JP)

Correspondence Address: SUGHRUE, MION, ZINN,, MACPEAK & SEAS, PLLC, Suite 800, 2100 Pennsylvania Avenue, N.W., Washington, DC, 20037-3213, US

(73) Assignee: FUJI PHOTO FILM CO., LTD.

(21) Appl. No.: 10/092,517

(22) Filed: Mar. 8, 2002

(30) Foreign Application Priority Data
Mar. 8, 2001 (JP) 2001-065227

(51) Int. Cl. H04N 5/225; H04N 3/14; H04N 5/335

(52) U.S. Cl. 348/342; 348/280; 348/223.1

(57) ABSTRACT

The image capturing method and apparatus capture an image of a subject with an image capturing device using image capturing optics and subject an image capturing signal from the image napturing device to specified processing schemes including a color separating process, thereby producing an image signal. The method and apparatus determine whether sensitivity of the image capturing device is insufficient or not during image capturing; when the sensitivity of the image capturing device is insufficient, relatively increase at least one of an overlapping region of spectral sensitivity of the image capturing device and intensity of the color separation process; and when the sensitivity of the image capturing device is sufficient, relatively decrease at least one of the overlapping region of the spectral sensitivity of the image capturing device and the intensity of the color separating process.

### BACKGROUND OF THE INVENTION

1. Field of the Invention

This invention relates to a method and apparatus for capturing image. The invention more particularly relates to technology of improving sensitivity in CCD-based digital still cameras and the like.

2. Related Background Art

Most of the conventional cameras use silver halide photography and record image on a film by means of lenses and other optics. Recently, such silver halide cameras are increasingly supplanted by digital still cameras which capture image by a photoelectric transducer such as CCD using lenses and other optics, and which record image information on a recording medium such as a memory card.

The spectral sensitivity of CCD used for such digital still cameras is different than that of the human eye. The CCD has sensitivity to the infrared region of 700 nm or more as shown in FIG. 5. Then, an IR cutting filter having a spectral absorption waveform (waveshape) e.g. shown in FIG. 6 is usually arranged in the image capturing optical path of the conventional CCD-based digital still camera, so that the infrared region is cut off thereby improving color separation ability. Thus, irrespective of whether sensitivity of the image capturing device during image capturing is insufficient (this is commonly called the case of “low sensitivity”) or sufficient (“high sensitivity”), the physical manner that an IR cutting filter is arranged, is adopted to improve the color separation ability.

In conventional cameras, if the sensitivity is insufficient, pictures are usually taken with “open” aperture. However, if the sensitivity is still insufficient, a shutter speed is slowed down. If this is still unsatisfactory, a CCD-based digital still camera increases the sensitivity by applying more voltage to the CCD, i.e. by increasing a gain.

However, if the aperture is made “open” in order to increase sensitivity, a depth of field decreases. If the shutter speed is slowed down in order to increase sensitivity, occurrence of lens movement more often increases and a blurred image is prone to develop. If the gain is increased, noise also increases to deteriorate image quality.

### SUMMARY OF THE INVENTION

The present invention has been accomplished in view of these circumstances. The invention has an object to provide an image capturing method and apparatus which determine if the sensitivity of an image capturing device during image capturing is sufficient or not and capture an image and performs a color separating process in accordance with the result of the determination and which can compensate for insufficiency of the sensitivity of the image capturing device without increasing chance for the occurrence of lens movement and noise generation.

The above object is achieved by an image capturing method in which an image of a subject is captured by an image capturing device using image capturing optics and an image capturing signal from the image capturing device is subjected to specified processing schemes including a color separating process, thereby producing an image signal, the method comprising the steps of: determining whether sensitivity of the image capturing device is insufficient or not during image capturing; when the sensitivity of the image capturing device is insufficient, relatively increasing at least one of an overlapping region of spectral sensitivity of the image capturing device and intensity of the color separation process; and when the sensitivity of the image capturing device is sufficient, relatively decreasing at least one of the overlapping region of the spectral sensitivity of the image capturing device and the intensity of the color separation process.

The above object is also achieved by the image capturing method according thereto, wherein the overlapping region of the spectral sensitivity of the image capturing device is an infrared region.

The above object is also achieved by the image capturing method according thereto, wherein the color separation process is an Under Color Removal scheme.

Further the above object is achieved by an image capturing apparatus comprising: an image capturing device that captures an image of a subject using image capturing optics; a device for producing an image signal by performing specified processing schemes including a color separation process on an image capturing signal from the image capturing device, a device which determines whether sensitivity of said image capturing device is insufficient or not during image capturing; at least one of a device which, when the sensitivity of the image capturing device is insufficient, relatively increases an overlapping region of spectral sensitivity of the image capturing device and a device which, when the sensitivity of the image capturing device is insufficient, relatively increases intensity of the color separating process; and at least one of a device which, when the sensitivity of the image capturing device is sufficient, relatively decreases the overlapping region of the spectral sensitivity of the image capturing device and a device which, when the sensitivity of the image capturing device is sufficient, relatively decreases the intensity of the color separating process.

The above object is also achieved by the image capturing apparatus wherein the overlapping region of the spectral sensitivity of the image capturing device is an infrared region.

The above object is also achieved by the image capturing apparatus wherein the color separating process is an Under Color Removal scheme.

### BRIEF DESCRIPTION OF THE DRAWINGS

FIG. 1 is a block diagram showing an outline of an image capturing apparatus according to an embodiment of the invention;

FIG. 2 illustrates how image data are transformed in the embodiment shown in FIG. 1;

FIG. 3 is a graph depicting ST 709 and sRGB which are two specifications for transformation between image data and the amount of exposure;

FIG. 4 illustrates an adaptive method of Under Color Removal;

FIG. 5 is a graph showing an example of CCD's spectral sensitivity; and

FIG. 6 is a graph showing an example of the spectral absorption waveform of an IR cutting filter.

### DESCRIPTION OF THE PREFERRED EMBODIMENT

The image capturing method and apparatus relating to the invention will be described in detail with reference to the preferred aspect illustrated in accompanying drawings.

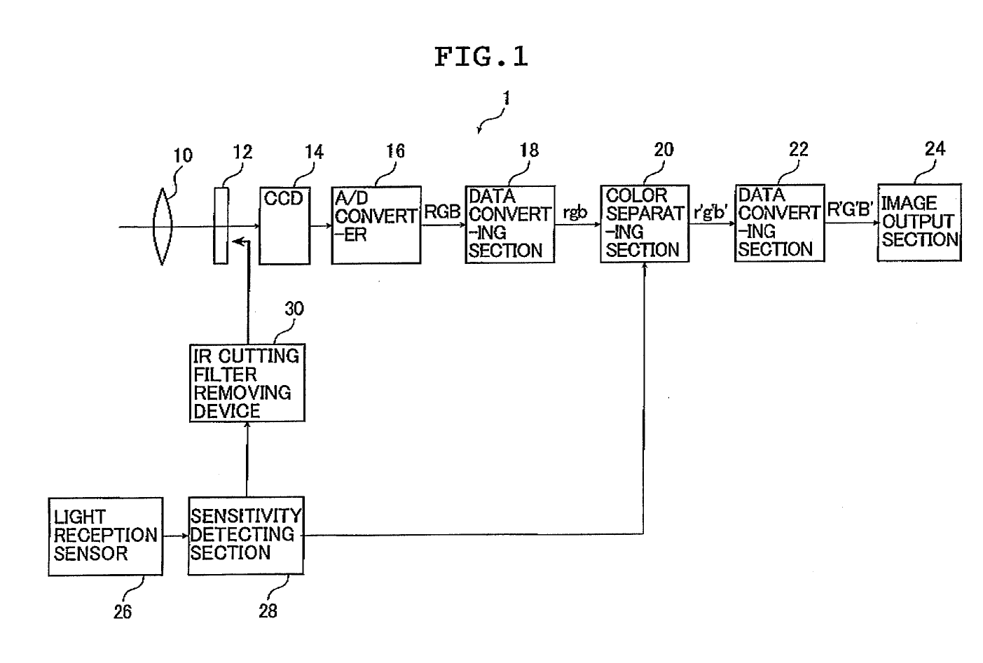

FIG. 1 is a block diagram showing an outline of an image capturing apparatus of an aspect of the invention.

An image capturing apparatus 1 is e.g. a digital still camera for capturing a still image or a digital video camera for capturing a moving image and the apparatus 1 has an image capturing device composed by a CCD 14. During normal image capturing (photographing), an optical image of a subject captured by way of an image capturing lens 10, an IR cutting filter 12 and the like is focused onto the CCD 14 working as an image capturing device. The CCD 14 photoelectrically converts the focused optical image into an electric signal and outputs an analog image signal in response to instructions from a control circuit (not shown). The output analog image signal is sent to an A/D converter 16 where it is converted to an 8-bit digital image signal RGB.

The 8-bit digital image signal RGB is sent to a data converting section (data converter) 18 where it is converted to exposure data rgb. The exposure data rgb is sent to a color separating section 20 where it is subjected to a color separating process. The resulting exposure data r′g′b′ is sent to a data converting section (data converter) 22 where it is again converted to an 8-bit digital image signal R′G′B′ which is subsequently output to an image output section 24. The image output section 24 displays an image on the monitor or outputs image data to a specified recording medium.

The apparatus 1 further has a light reception sensor 26, a sensitivity detecting section 28 and an IR cutting filter removing device 30. Information about brightness from the subject as detected with the light reception sensor 28 is sent to the sensitivity detecting section 28 which then determines whether the sensitivity of the CCD 14 is sufficient or not. If the sensitivity is found to be insufficient and i.e. found out to be low sensitivity, the IR cutting filter removing device 30 removes the IR cutting filter 12 from the image capturing optical path so that an overlapping region of spectral sensitivity of the CCD 14 increases relatively in comparison with a case where the IR cutting filter 12 is arranged in the image capturing optical path. The signal of insufficient sensitivity detected by the sensitivity detecting section 28 is further sent to the color separating section 20 which, upon receiving the signal for insufficient sensitivity, increases the intensity of the color separation process relatively, likewise. On the other hand, if the sensitivity is found to be sufficient, i.e. found to be high sensitivity, the IR cutting filter 12 is arranged into the image capturing optical path, so that the overlapping region of the spectral sensitivity of the CCD region 14 as well as the intensity of the color separating process are respectively decreased. Note that the overlapping region of the spectral sensitivity of the CCD 14 and the intensity of the color separating process may both be adjusted or, alternatively, either one of them may be adjusted. For further details, see below.

Although not described in detail, the apparatus 1 may also include conventional devices and circuits such as a signal amplifier, a white balance circuit, circuits for effecting γ (gamma) correction and the other image process, and a control circuit for controlling each of the circuits. The apparatus 1 may also have an AF (auto-focusing) mechanism, an AE (auto-exposing) mechanism, and the like. If the apparatus 1 has the AE mechanism, detection for low sensitivity may be performed by the AE mechanism The operation of the embodiment under consideration and the image capturing method of the present invention will be explained.

In a case of insufficient sensitivity (low sensitivity) as when an image of a dark subject is taken under dark illumination, the IR cutting filter is removed from the image capturing optical path, so that the infrared region of incident light on the CCD that has been cut off by the IR cutting filter, is restored and the overlapping region of the spectral sensitivity of the CCD is increased thereby improving its sensitivity in comparison with the case where the IR cutting filter is arranged into the image capturing optical path. It is preferred that the intensity of the color separating process is further increased relatively as below. Because the sensitivity is improved but the color separation ability is deteriorated. For instance, signal processing by a masking technique such as Under Color Removal that does not further generate noise may be performed thereby removing impurity of color.

In a case of high sensitivity where the sensitivity of the CCD is sufficient, the IR cutting filter is arranged into the image capturing optical path, so that light in the overlapping region of the spectral sensitivity of the CCD is decreased in comparison with the case where the IR cutting filter is removed. In this case, it is preferred that the intensity of the color separating process may also be relatively thereto.

When performing the process of image capturing by the apparatus 1, first, the brightness of the subject with the light reception sensor 26 is detected. Information about the brightness as detected with the light reception sensor 26 is sent to the sensitivity detecting section 28, which determines whether the sensitivity of the COD 14 is insufficient (low sensitivity) or not (high sensitivity).

For example, the determination may be carried out as follows. A picture is taken with the IR cutting filter 12 arranged into the image capturing optical path. If the average over the entire image plane for the G (green) channels is smaller than 80, the sensitivity of the CCD 14 is found to be insufficient, i.e. found to be low sensitivity; if the defined average is greater than 80, the sensitivity of the CCD 14 is found to be sufficient, i.e. found out to be high sensitivity.

If the sensitivity of the CCD 14 is found to be insufficient, the sensitivity detecting section 28 sends the relevant signal to the IR cutting filter removing device 30 and then removes the IR cutting filter 12 from the image capturing optical path.

Thus, in the case of low sensitivity, image capturing is effected without the IR cutting filter 12.

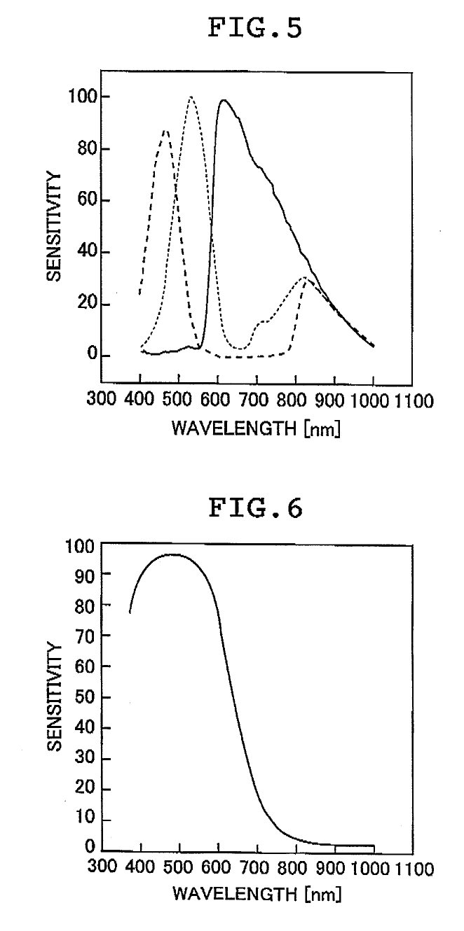

Since the IR cutting filter 12 is not removed from the image capturing optical path during image capturing, the spectral sensitivity of the CCD 14 is as shown in FIG. 5; it also has sensitivity in the infrared region and the overlapping region of its spectral sensitivity is widen to improve sensitivity.

Optical image of the subject is focused on the CCD 14, photoelectrically converted to an electrical signal by the CCD 14 and output as an analog image signal. The output analog image signal is sent to the A/D converter 16 where the signal is converted into 8-bit digital image data RGB.

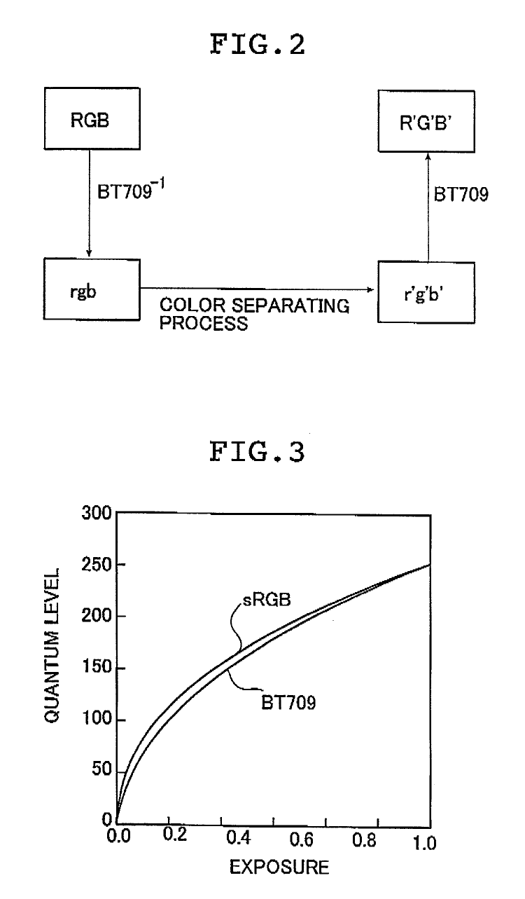

As shown in FIG. 2, the 8-bit digital image data RGB is converted to exposure data rgb by the data converter 18, then subjected to a color separating process in the color separating section 20, and the resulting exposure data r′g′b′ is converted to another 8-bit digital image data R′G′B′ by the data converter 22. Thereafter the digital image data R′G′B′ is output from the image output section 24.

In the data converter 18, the 8-bit digital image data RGB is converted to the exposure data rgb by BT 709 (see FIG. 3) which is a specification recommended for HDTV by ITU-R (International Telecommunication Union—Radio communication sector). The exponent “−1” in BT 709⁻¹ in FIG. 2 represents transformation from the data on light quantity (quantum level) to the data on the amount of exposure. Alternatively, this transformation may be performed by sRGB which is a specification adopted by IEC (International Electrotechnical Commission) for the monitoring process.

The color separating section 20 performs a color separating process (masking) and this is accomplished by the so-called under color removal operation in which each of a constant value is subtracted from the data on each of the colors as indicated by the following equations (1)-(3):

r′=r−0.10 (1)

g′=g−0.12 (2)

b′=b−0.13 (3)

The amounts of Under Colors to be removed, need not be fixed but may be determined adaptively by comparing two kinds of image data, one being the image data obtained by image capturing with the IR cutting filter being inserted in the image capturing optical path and the other being the image data obtained by image capturing, removing the IR cutting filter.

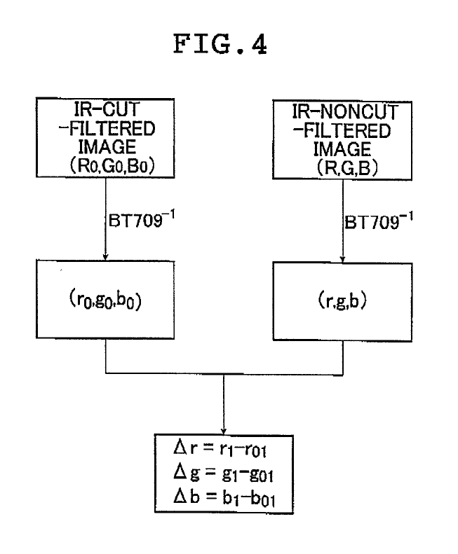

As shown in FIG. 4, i.e. the image data (R₀,G₀,B₀) (IR-cut-filtered image data) obtained by image capturing with the IR cutting filter 12 being arranged in the image capturing optical path and the image data (R,G,B) (IR-non-cut-filtered image data) obtained by image capturing without the IR cutting filter 12, are transformed to exposure data (r₀,g₀,b₀) and (r,g,b), respectively, using BT 709.

Then, r₀₁, g₀₁ and b₀₁ are obtained which are the averages of r₀, g₀ and b₀ over a specified range of the image. Similarly, r₁, g₁ and b₁ are determined which are the averages of r, g and b for a specified range of the image. Difference between the respective counterparts is determined as follows:

Δr=r₁−r₀₁

Δg=g₁−g₀₁

Δb=b₁−b₀₁

By substituting the following equations (4)-(6) for the equations (1)-(3), a proper Under Color Removal can be realized;

r′=r−Δr (4)

g′=g−Δg (5)

b′=b−Δb (6)

The color separation process is by no means limited to the above-described Under Color Removal schemes and may be carried out by a matrix operation on the exposure data as indicated by the following equation (7)

$$( \begin{matrix}{r}^{′} \\ {g}^{′} \\ {b}^{′}\end{matrix} ) = ( \begin{matrix}{α}_{11} & {α}_{12} & {α}_{13} \\ {α}_{21} & {α}_{22} & {α}_{23} \\ {α}_{31} & {α}_{32} & {α}_{33}\end{matrix} ) ( \begin{matrix}r \\ g \\ b\end{matrix} ) \qquad ( 7 )$$

Alternatively, a matrix operation on 8-bit data may be performed as indicated by the following equation (8):

$$( \begin{matrix}{R}^{′} \\ {G}^{′} \\ {B}^{′}\end{matrix} ) = ( \begin{matrix}{β}_{11} & {β}_{12} & {β}_{13} \\ {β}_{21} & {β}_{22} & {β}_{23} \\ {β}_{31} & {β}_{32} & {β}_{33}\end{matrix} ) ( \begin{matrix}R \\ G \\ B\end{matrix} ) \qquad ( 8 )$$

If desired, the intensity of the color separation process such as Under Color Removal schemes or matrix operations may be increased in accordance with the degree of low sensitivity as detected by the sensitivity detecting section 28. Namely, the color separating section 20 may alter the coefficients in the above-described Under Color Removal schemes or matrix operations on the basis of the detection signal sent from the sensitivity detecting section 28 and the intensity of the color separation process may be changed.

The intensity of the color separation process may be changed by a photographer who operates the apparatus 1 while observing an image displayed on the image output section 24. If the photographer knows in advance that pictures are to be taken under a low-sensitivity environment, the photographer may remove the IR cutting filter during image capturing or, alternatively, the IR cutting filter may be removed from the image capturing apparatus before operated it.

The image data (r′,g′,b′) emerging from the color separating section 20 after the color separation process is sent to the data converting section 22 where it is converted to another 8-bit digital image data (R′,G′,B′). This step of conversion is also achieved by ST 709 shown in FIG. 3. The converted digital image data (R′,G′,B′) is output from the image output section 24.

Thus, if the IR cutting filter is removed from the image capturing optical path when the sensitivity of the CCD 14 is found to be insufficient, ability of color separation deteriorates but the signal level is “padded” to a higher level, so noise due to heat noise can be relatively reduced. In addition, if the impurity of colors is removed by masking such as Under Color Removal which does not increase noise, sensitivity can be improved without causing camera to be displayed by the photographer or being affected by noise.

If the sensitivity detecting section 28 finds that the sensitivity of the CCD 14 is sufficient, it sends the relevant signal to the IR cutting filter removing device 30 so that the IR cutting filter 12 is arranged into the image capturing optical path. Thus, in the case of high sensitivity, images are captured under the presence of the IR cutting filter 12. Since the IR cutting filter 12 is in the image capturing optical path, the overlapping region of the spectral sensitivity of the CCD 14 is decreased compared to the case where no IR cutting filter is used.

In addition, intensity of the color separation process to be performed in the color separating section 20 is relatively decreased in comparison with the case of low sensitivity.

In the conventional art, color separation has been always accomplished by the physical construction of arrangement of an IR cutting filter irrespective of the image capturing sensitivity. In the present embodiment described above, decision is first made as to whether the sensitivity of the image capturing device during imaging is insufficient (low sensitivity) or not (high sensitivity) and if it is found to be high, color separation is performed by the physical manner or means of inserting the IR cutting filter. In the case of low sensitivity, the IR filter is removed and color separation is performed mainly i.e. by processing with software such as by altering the coefficients in matrix operations.

While the image capturing method and apparatus of the invention have been described above in detail, it should be noted that the invention is by no means limited to the foregoing example and various improvements and modifications can be made without departing from the scope and spirit of the invention.

As above-described, according to the invention, a photographer can take a picture and perform a color separating process in accordance with an amount of available image capturing light and can compensate for any insufficiency in sensitivity of the image capturing device without increasing the chance for occurrence of lens displacement by the photographer and noise generation.

What is claimed is:

1. An image capturing method in which an image of a subject is captured by an image capturing device using image capturing optics and an image capturing signal from said image capturing device is subjected to specified processing schemes including a color separating process, thereby producing an image signal, said method comprising the steps of:
determining whether sensitivity of said image capturing device is insufficient or not during image capturing;
when the sensitivity of said image capturing device is insufficient, relatively increasing at least one of an overlapping region of spectral sensitivity of said image capturing device and intensity of said color separating process; and
when the sensitivity of said image capturing device is sufficient, relatively decreasing at least one of the overlapping region of the spectral sensitivity of said image capturing device and the intensity of said color separating process.

2. The image capturing method according to claim 1, wherein the overlapping region of the spectral sensitivity of said image capturing device is an infrared region.

3. The image capturing method according to claim 1, wherein said color separating process is an Under Color Removal scheme.

4. An image capturing apparatus comprising:
an image capturing device that captures an image of a subject using image capturing optics;
a device for producing an image signal by performing specified processing schemes including a color separation process on an image capturing signal from said image capturing device;
a device which determines whether sensitivity of said image capturing device is insufficient or not during image capturing;
at least one of a device which, when the sensitivity of said image capturing device is insufficient, relatively increases an overlapping region of spectral sensitivity of said image capturing device and a device which, when the sensitivity of said image capturing device is insufficient, relatively increases intensity of said color separating process; and
at least one of a device which, when the sensitivity of said image capturing device is sufficient, relatively decreases the overlapping region of the spectral sensitivity of said image capturing device and a device which, when the sensitivity of said image capturing device is sufficient, relatively decreases the intensity of said color separating process.

5. The image capturing apparatus according to claim 4, wherein the overlapping region of the spectral sensitivity of said image capturing device is an infrared region.

6. The image capturing apparatus according to claim 4, wherein said color separating process is an Under Color Removal scheme.
